(19) United States
(12) Patent Application Publication
(10) Pub. No.: US 2003/0164396 A1
(43) Pub. Date: Sep. 4, 2003

(54) Mounting method and device

(76) Inventors: Tadatomo Suga, Tokyo (JP); Akira Yamauchi, Shiga (JP)

Correspondence Address: SMITH PATENT OFFICE, 1901 PENNSYLVANIA AVENUE N W, SUITE 200, WASHINGTON, DC, 20006

(21) Appl. No.: 10/344,938

(22) PCT Filed: Aug. 6, 2001
(86) PCT No.: PCT/JP01/06736

(30) Foreign Application Priority Data
Aug. 18, 2000 (JP) 2000-248655

(51) Int. Cl. B23K 31/02

(52) U.S. Cl. 228/219; 228/42; 219/121.6

(57) ABSTRACT

A mounting method for bonding a first object having a metal joint part to a second object, comprising the steps of cleaning at least the surface of the metal joint part of the first object by irradiating an energy wave or energy particle beam, and thermally bonding the cleaned metal joint part of the first object to a portion to be bonded of the second object by heating in a special gas atmosphere, and a device thereof. In the mounting, the primary and secondary oxidations of the metal joint part can be efficiently prevented, and thereby highly reliable bonding can be carried out.

### TECHNICAL FIELD OF THE INVENTION

The present invention relates to mounting method and device for bonding an object such as a chip having a metal joint part such as a solder bump to another object such as a substrate, and specifically to mounting method and device in which the oxidation of the metal joint part can be efficiently prevented.

### BACKGROUND ART OF THE INVENTION

A mounting method for bonding an object with a metal joint part such as a solder joint part to another object, for example, a chip mounting method for forming a solder bump on a chip, approaching the chip to a substrate at a face-down condition, bringing the solder bump into contact with a pad of the substrate, and thereafter heating and melting the bump of the chip to bond it to the pad of the substrate, is well known. In such a flip-chip process using a solder bump, there is a fear that the solder bump is primarily oxidized before bonding step by being touched with an atmosphere, etc., and further, there is a fear that the bump is secondarily oxidized by heating under an oxidization gas atmosphere at the time of heat bonding or a time immediately before the heat bonding. If such a primary or secondary oxidation occurs, namely, if there exists an oxide on the surface of the bump, there is a fear that a desired bonding state cannot be obtained between the bump and the pad of the substrate. Since in most cases a plating such as gold is usually performed on the pad of the substrate, primary oxidation and secondary oxidation may not occur on the pad side of the substrate.

In order to prevent the secondary oxidation of a solder bump, a method for blowing nitrogen gas into a gap between a chip and a substrate as a purge gas has been known, and the bump is bonded to the pad of the substrate in a nitrogen gas atmosphere. For example, as shown in FIG. 7, a chamber 102 is provided so as to surround a substrate 101, nitrogen gas (N₂ gas) is blown into the chamber 102 to replace the air in the chamber 102 to the nitrogen gas, a chip 104 held on a tool 103 is moved down, and bumps 105 of the chip 104 are bonded to pads 106 of the substrate 101 at a condition of the nitrogen gas atmosphere in the chamber 102.

However, because this conventional method basically aims to prevent secondary oxidation, the method is substantially not effective for preventing primary oxidation such as one described above. Further, with this effect for preventing secondary oxidation, in the method using the conventional chamber 107 such as one shown in FIG. 7, because an outside air is involved particularly from an opening 107 which is provided on the chamber 102 for the vertical movement of the tool, practically it is difficult to increase the concentration of the nitrogen gas in the chamber 102 up to a concentration effective for prevention of secondary oxidation.

On the other hand, recently, a room-temperature bonding method, due to activation of surfaces of objects to be bonded using an energy wave or energy particle beam, has been paid attention to. For example, in Japanese Patent 2,791,429 discloses a room-temperature bonding method of silicon wafers for sputter etching the bonding surfaces of both silicon wafers by irradiating an inert gas ion beam or an inert gas high-speed atomic beam to the surfaces at a vacuum condition with a room temperature prior to the bonding. In this room-temperature bonding method, oxides or organic substances on the bonding surfaces of silicon wafers are removed by the above-described beam and the surfaces are formed by silicon atoms activated by the beam, and both surfaces are bonded to each other by a strong bonding force between the activated atoms. Therefore, in this method, heating for bonding is not necessary, and it is possible to bond the objects at a room temperature. Further, in a case where the surface irregularity is small (the flatness is high), it also becomes possible to make pressing for bonding unnecessary.

This room-temperature bonding method is advantageous particularly for a case where the parts of the objects to be bonded to each other are formed from a same kind of materials. Therefore, it seems to be difficult to apply this method to the bonding of a chip having a solder bump which basically is thermally bonded and a substrate having a pad which is formed from a material different from that of the solder bump.

However, the inventor of the present invention have paid attention to the excellent cleaning effect that the oxides and organic substances on the bonding surface are effectively removed by the irradiation step of the energy wave or energy particle beam in the excellent bonding method which was disclosed as the above-described room-temperature bonding method, and have considered that this step can be applied for the cleaning of a metal joint part of an object which basically is thermally bonded, thereby obtaining an advantage to prevent the primary oxidation of the metal joint part, and the present invention has been completed.

### DISCLOSURE OF THE INVENTION

A purpose of the present invention is to provide mounting method and device which can prevent both the primary and secondary oxidations of a metal joint part effectively, thereby achieving an extremely highly reliable bonding, when an object, which has a metal joint part and basically is thermally bonded, is mounted.

To achieve the above-described purpose, a mounting method according to the present invention for bonding a first object having a metal joint part to a second object, comprises the steps of cleaning at least a surface of the metal joint part of the first object by irradiating an energy wave or energy particle beam thereto; and thermally bonding the cleaned metal joint part of the first object to a portion to be bonded of the second object by heating in a special gas atmosphere.

The metal joint part in the present invention means a generic term of a joint part due to a metal including a joint part due to a usual solder of lead/tin, and other joint parts due to a so-called substitute solder such as tin/silver or Bi/In and joint parts due to gold/tin or gold/gold. Further, the special gas in the present invention means an inert gas or a gas which does not react with at least the metal joint part, and as this special gas, for example, an inert gas such as argon gas, a gas such as nitrogen gas which does not react with the objects, a gas which can replace the surface oxides to fluoro groups and the like on the surfaces of the objects, a gas which contains hydrogen and can react at a reducing condition on the surfaces of the objects, a gas which contains oxygen and can remove carbons (organic substances) on the surfaces of the objects, etc., can be raised.

In the mounting method according to the present invention, it is possible to perform the above-described cleaning at an atmospheric pressure condition depending upon the kind of the energy wave or energy particle beam. Namely, in this method, because the irradiation of the energy wave or energy particle beam aims not to activate the surface of the object up to a degree at which a room-temperature bonding becomes possible but to remove the oxides and organic substances on the surface up to a degree at which the primary oxidation of the metal joint part can be prevented, a vacuum condition as required in the room-temperature bonding method is not necessary, and basically it is possible to perform the cleaning at an atmospheric pressure condition. Further, in order to further increase the cleaning effect, it is possible to perform the cleaning in the above-described special gas atmosphere. As the energy wave or energy particle beam, any of a plasma (including an atmospheric-pressure plasma), an ion beam, an atomic beam, a radical beam and a laser can be used.

Further, since the cleaned metal joint part of the first object is thermally bonded to the portion to be bonded of the second object in the above-described special gas atmosphere, the secondary oxidation of the metal joint part also can be prevented. In order to prevent the secondary oxidation more effectively, it is preferred to form a high-concentration special gas atmosphere particularly at a portion around the metal joint part immediately before bonding. For this, for example, it is preferred that the above-described special gas atmosphere is formed by supplying a special gas locally toward at least a portion around the metal joint part while maintaining a gap between the first object and the second object before bonding at an open condition. A gas forming an oxidizing atmosphere, represented by air or water vapor, can be driven out by the supplied special gas, and the atmosphere around the bonding portion can be formed as a non-oxidizing atmosphere.

A mounting device according to the present invention for bonding a first object having a metal joint part to a second object comprises a cleaning means for cleaning at least a surface of the metal joint part of the first object by irradiating an energy wave or energy particle beam thereto; a heat bonding means for bonding the metal joint part of the first object cleaned by the cleaning means to a portion to be bonded of the second object by heating; and a gas atmosphere forming means for forming a special gas atmosphere around a portion to be thermally bonded by the heat bonding means. By the heating, it becomes possible to remove a fine gap and a residual stress on an interface between both objects.

Also in this mounting device, the above-described cleaning means can be provided in an atmosphere at an atmospheric pressure. Further, in order to further increase the cleaning effect, a gas atmosphere forming means for forming a special gas atmosphere can be provided also to the cleaning means. As the energy wave or energy particle beam for the cleaning means, any of a plasma, an ion beam, an atomic beam, a radical beam and a laser can be used. Furthermore, it is preferred that the gas atmosphere forming means of the bonding part comprises a purge gas blowing means for blowing out a purge gas locally toward at least a portion around the metal joint part in a gap opened between the first object and the second object before bonding.

In such mounting method and device according to the present invention, the oxides and organic substances present on the surface of the metal joint part of the first object are adequately removed by irradiating the energy wave or energy particle beam thereto, and the primary oxidation of the metal joint part can be effectively prevented for the period of time up to the bonding. Besides, since the heat bonding is carried out in a non-oxidizing special gas atmosphere such as an atmosphere of an inert gas or a gas which does not react with the metal joint part, the secondary oxidation ascribed to the heating also can be prevented effectively, and further, not only the oxidation is prevented, but also a reaction and an adhesion of contaminations at the metal surface, which obstruct the bonding, can be prevented. Therefore, the primary and secondary oxidations can be both prevented effectively up to the time of the actual completion of the heat bonding, and an extremely high-reliability bonding state can be achieved.

### BRIEF EXPLANATION OF THE DRAWINGS

FIG. 1 is a schematic view of a mounting device according to an embodiment of the present invention.

FIG. 2 is an enlarged partial elevational view of the mounting device depicted in FIG. 1, showing a state for cleaning due to an energy wave or energy particle beam.

FIG. 3 is an enlarged partial elevational view of the mounting device depicted in FIG. 1, showing a state for heat bonding.

FIG. 4 is a schematic view of a gas atmosphere forming means according to another embodiment of the present invention.

FIG. 5 is a schematic view of a gas atmosphere forming means according to a further embodiment of the present invention.

FIG. 6 is a schematic view of a gas atmosphere forming means according to a still further embodiment of the present invention.

FIG. 7 is a schematic view of a bonding part of a conventional mounting device.

### THE BEST MODE FOR CARRYING OUT THE INVENTION

Hereinafter, desirable embodiments of the present invention will be explained referring to figures.

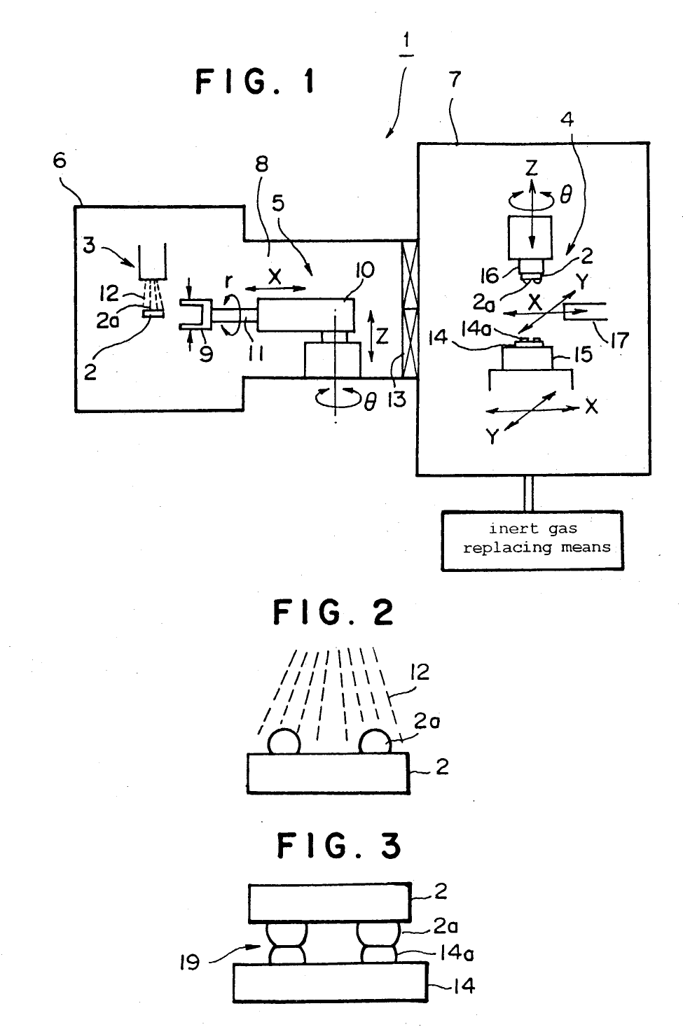

FIGS. 1 to 3 show a mounting device according to an embodiment of the present invention. In FIG. 1, numeral 1 indicates the whole of a mounting device, and the mounting device 1 comprises a cleaning means 3 for cleaning at least solder bumps 2a provided as metal joint parts on a first object 2 (for example, an IC chip), a bonding means 4 for bonding the solder bumps 2a of the first object 2 cleaned by the cleaning means 3 to pads 14a provided on a second object 14 (for example, a substrate), and a conveying robot 5 provided as a conveying means for being disposed between the cleaning means 3 and the bonding means 4 and for conveying at least the first object 2 cleaned by the cleaning means 3 to the bonding means 4.

In this embodiment, cleaning means 3 is installed in a cleaning chamber 6, and bonding means 4 is installed in a bonding chamber 7. Cleaning chamber 6 and bonding chamber 7 communicate with each other via a conveying part 8, and conveying robot 5 is disposed in this conveying part 8.

Conveying robot 5 has an end arm 9 capable of holding and releasing object 2, and the end arm 9 attached to a robot body 10 via a rod 11 capable of extending in the axial direction (in the X direction) and provided so as to be rotated in the “r” direction around the center axis of the rod 11. Further, robot body 10 can be moved and adjusted in the vertical direction (in the Z direction) and in the rotational direction (in the θ direction). Although not shown, this conveying may be performed, for example, so as to hold a single or a plurality of objects 2 on a tray and convey the tray by a conveying means such as conveying robot 5.

Cleaning means 3 comprises means for irradiating an energy wave or energy particle beam 12 at least toward the surfaces of solder bumps 2a, which become bonding surfaces of first object 2, thereby cleaning the surfaces. As energy wave or energy particle beam 12, as aforementioned, a plasma, an ion beam, an atomic beam, a radical beam or a laser is used. This cleaning can be carried out at an atmospheric pressure condition depending upon the kind of energy wave or energy particle beam 12. Further, in order to further increase the cleaning effect, a gas replacing means for forming an aforementioned special gas atmosphere may be provided (not shown).

A shutter means 13 for controlling the communication and the interruption thereof between bonding chamber 7 and conveying part 8 installed with conveying robot 5 is provided to the bonding chamber 7 containing bonding means 4. This shutter means 13 is closed for interrupting the communication with conveying part 8, when the inside of bonding chamber 7 is made to a predetermined gas atmosphere before bonding, and during the bonding operation, and it is opened when the respective objects to be bonded are introduced into the bonding chamber 7 and when the objects after bonding are taken out from the bonding chamber 7, so that conveying robot 5 can be proceeded and retreated.

A gas atmosphere forming means 18 is attached to bonding chamber 7 for forming a predetermined special gas atmosphere in the bonding chamber 7. In this embodiment, this gas atmosphere forming means 18 is formed as an inert gas replacing means. As the inert gas, for example, argon gas can be used.

Bonding means 4 thermally bonds the cleaned solder bumps 2a of first object 2 to pads 14a of second object 14. This bonding means 4 has, for example, a stage 15 for holding second object 2 and a tool 16 for holding first object 2 which has a function for heating. In this embodiment, for alignment for the heat bonding, stage 15 can be adjusted in position in the X and Y directions (in the horizontal direction), and tool 16 can be adjusted in the Z direction (in the vertical direction) and in the rotational direction (in the θ direction). Further, in order to detect a positional shift between the upper and lower objects and to adjust the positional relationship therebetween within a desired accuracy based on the detected amount, a two-sight camera 17 having upper and lower sights is provided between stage 15 and tool 16 so as to be proceeded to and retreated from a portion therebetween, as a recognition means for reading the recognition marks provided on upper and lower object sides. This two-sight camera 17 can also be adjusted in position in the X and Y directions (as needed, further in the Z direction (in the vertical direction)). This recognition means may be formed as recognition means for separatedly recognizing the recognition marks provided on upper and lower object sides, respectively.

In this embodiment, the atmosphere in bonding chamber 7 is formed as an inert gas atmosphere by inert gas replacing means 18 before heat bonding, and at that state, the heat bonding is carried out. As the gas atmosphere in bonding chamber 7, except the inert gas atmosphere, a special gas atmosphere such as one aforementioned, for example, a gas atmosphere which does not react with the objects can be employed, and for example, in a case where en electrode provided on an object is bonded to an electrode provided on another object, it is possible to form a gas atmosphere using a gas which does not react with the electrode (for example, nitrogen gas). The heat bonding in bonding chamber 7 can be carried out at a condition of either an atmospheric pressure or a reduced pressure. Particularly, if carried out at an atmospheric pressure condition, simplification in device and control of gas atmosphere becomes possible.

The mounting method according to the present invention is carried out using the mounting device 1 thus constructed.

First object 2 is introduced into cleaning chamber 6, and as shown in FIG. 2, at least the surface of solder bumps 2a of the first object 2 is cleaned by irradiation of energy wave or energy particle beam 12. This cleaning can be carried out at an atmospheric pressure condition as aforementioned. The oxides and organic substances are removed from the surfaces of solder bumps 2a by the cleaning due to energy wave or energy particle beam 12, and the surfaces are maintained to be in a clean condition and prevented from primary oxidation. If second object 14 side is also required to be prevented from primary oxidation, a similar cleaning due to energy wave or energy particle beam 12 may be carried out.

Second object 14 and first object 2 with cleaned solder bumps 2a are introduced into bonding chamber 7, and the heat bonding is carried out. In this embodiment, at the time of the heat bonding, shutter means 13 is closed, the inside of bonding chamber 7 is formed as an inert gas atmosphere by inert gas replacing means 18, and the heat bonding is carried out in the atmosphere. As shown in FIG. 3, since solder bumps 2a of first object 2 prevented from primary oxidation are thermally bonded to pads 14a of second object 14 in inert gas atmosphere 19, secondary oxidation due to heating can also be prevented effectively. Namely, the primary and secondary oxidations are both prevented, and a highly reliable bonding state can be achieved.

Although the whole of the inside of bonding chamber 7 is replaced to an inert gas in the above-described embodiment, in order to prevent the secondary oxidation more surely, a method can be employed wherein the atmosphere around solder bumps 2a immediately before heat bonding is preferentially replaced to a high-concentration inert gas effectively.

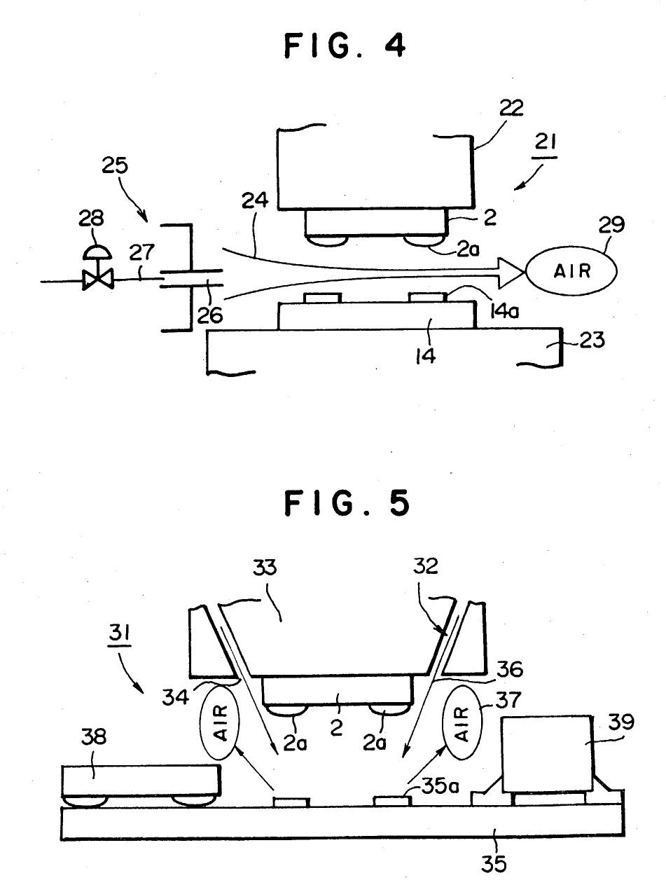

For example, in the embodiment shown in FIG. 4, the gap between first object 2 held on tool 22 and second object 14 held on stage 23 in bonding means 21 is maintained at an open condition immediately before the heat bonding, and from the side of this gap, a non-oxidizing purge gas 24 such as an inert gas is blown put locally toward at least the portion around solder bumps 2a. Purge gas blowing means 25 comprises a discharge port 26, a flow path 27 for supplying the purge gas toward the discharge port 26 and a flow rate control valve 28, and in order to push out air 29, which has been present in the above-described gap, efficiently so as not to involve air from surroundings and to replace the portion with the purge gas, for example, the purge gas is blown out at a small flow-rate condition such as a degree at which the flow becomes a laminar flow.

By providing such a gas atmosphere forming means, while the involvement of air from surroundings can be suppressed, at least the portions around solder bumps 2a can be maintained locally at a condition of a high purge-gas concentration. Therefore; the secondary oxidation of solder bumps 2a before heat bonding can be prevented extremely efficiently.

FIG. 5 shows another embodiment of a gas atmosphere forming means using a purge gas. In a bonding means 31 shown in FIG. 5, a purge gas blowing means 32 is constructed integrally with a tool 33. Purge gas discharge ports 34 are opened on the lower surface of tool 33 to be obliquely directed downward, and purge gas 36 is blown out toward a second object 35 having pads 35a, and particularly toward the lower surface side of first object 2 formed with solder bumps 2a. The purge gas 36 blown out pushes out air 37 which has been present between first object 2 and second object 35, particularly air around solder bumps 2a. Also in this blowing out of the purge gas, it is preferred to blow out the purge gas slowly so as not to involve air from surroundings, similarly to in the aforementioned embodiment.

Since the purge gas is blown out locally from tool 33 side, as shown in FIG. 5, this embodiment is effective particularly for a case where there is a chip 38 or another member 39, which has been already mounted, around a portion to be thermally bonded from now, for example, a case of a multi-chip mounting.

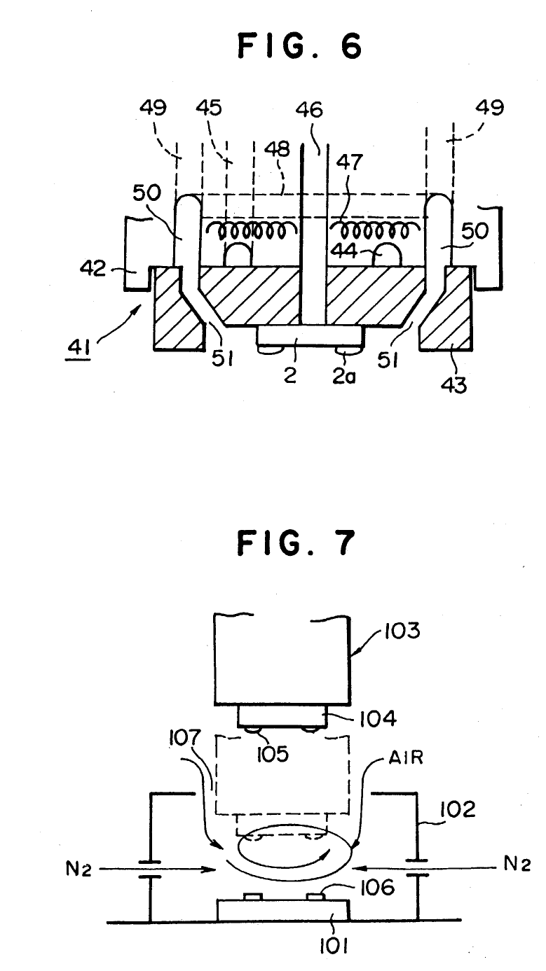

FIG. 6 shows a further embodiment of a gas atmosphere forming means using a purge gas. In the means shown in FIG. 6, an exchangeable, preferably, automatically exchangeable attachment 43 is attached to the lower end of a holder 42 of a tool 41, and first object 2 formed with solder bumps 2a is held on the lower surface of this attachment 43 by suction. Attachment 43 is held on the lower surface of holder 42 by suction from an annular tool suction groove 44 formed on the lower surface of holder 42, and the attachment 43 can be exchanged easily and automatically by controlling the suction operation through a suction path 45. First object 2 is sucked and held by suction due to a suction hole 46 extending through holder 42 and attachment 43.

A heater 47 for heating the purge gas is provided in holder 42, and a heating loop 48 extending in a form of an arc is formed as a path for heating the purge gas adjacently to the portion provided with the heater 47. The purge gas is introduced into heating loop 48 through purge gas supplying paths 49, and the purge gas heated in the heating loop 48 is blown out from purge gas discharge ports 51 opened on the lower surface of attachment 43 through flow paths 50 extending downward. The purge gas is blown out at a small flow rate, locally toward the portions around solder bumps 2a of first object 2.

By preheating the purge gas to be blown out, it becomes possible to suppress a reduction of the temperature due to the blowing out of the purge gas and to successively thermally bond solder bumps 2a at a condition where the temperature is maintained at a high temperature, at the bonding of the solder bumps 2a. Also in this embodiment, the concentration of purge gas around solder bumps 2a can be increased by the purge gas locally blown out, and the secondary oxidation can be prevented and a desirable heat bonding can be carried out efficiently.

Further, since purge gas discharge ports 51 are opened on attachment 43 and the attachment 43 can be automatically exchanged easily, an optimum purge gas blowing state can be realized depending upon the kind and the size of first object 2.

### INDUSTRIAL APPLICATIONS OF THE INVENTION

The mounting method and device according to the present invention can be applied to any type of mounting method and device for bonding objects with metal join parts to each other, and particularly, the primary and secondary oxidations of the metal joint parts can be efficiently prevented, and thereby highly reliable bonding can be carried out.

1. A mounting method for bonding a first object having a metal joint part to a second object, comprising the steps of:
cleaning at least a surface of said metal joint part of said first object by irradiating an energy wave or energy particle beam thereto; and
thermally bonding the cleaned metal joint part of said first object to a portion to be bonded of said second object by heating in a special gas atmosphere.

2. The mounting method according to claim 1, wherein said cleaning is carried out at an atmospheric pressure condition.

3. The mounting method according to claim 1, wherein said cleaning is carried out in a special gas atmosphere.

4. The mounting method according to claim 1, wherein a plasma, an ion beam, an atomic beam, a radical beam or a laser is used as said energy wave or energy particle beam.

5. The mounting method according to claim 1, wherein said special gas atmosphere is formed by supplying a special gas locally toward at least a portion around said metal joint part while maintaining a gap between said first object and said second object before bonding at an open condition.

6. A mounting device for bonding a first object having a metal joint part to a second object comprising:
a cleaning means for cleaning at least a surface of said metal joint part of said first object by irradiating an energy wave or energy particle beam thereto,
a heat bonding means for bonding said metal joint part of said first object cleaned by said cleaning means to a portion to be bonded of said second object by heating; and
a gas atmosphere forming means for forming a special gas atmosphere around a portion to be thermally bonded by said heat bonding means.

7. The mounting device according to claim 6, wherein said cleaning means is provided in an atmosphere at an atmospheric pressure.

8. The mounting device according to claim 6, wherein a gas atmosphere forming means for forming a special gas atmosphere is provided to said cleaning means.

9. The mounting device according to claim 6, wherein a plasma, an ion beam, an atomic beam, a radical beam or a laser is used as said energy wave or energy particle beam for said cleaning means.

10. The mounting device according to claim 6, wherein said gas atmosphere forming means comprises a purge gas blowing means for blowing out a purge gas locally toward at least a portion around said metal joint part in a gap opened between said first object and said second object before bonding.
